(19) United States
(12) Patent Application Publication
(10) Pub. No.: US 2013/0097100 A1
(43) Pub. Date: Apr. 18, 2013

(54) METHOD OF EVALUATING AND SELECTING EMPLOYMENT APPLICANTS

(71) Applicants: Tiffany D. Crenshaw, Greensboro, NC (US); Susan Brassell-Knox, New York, NY (US); Egan Visker, West Haven, CT (US)

(72) Inventors: Tiffany D. Crenshaw, Greensboro, NC (US); Susan Brassell-Knox, New York, NY (US); Egan Visker, West Haven, CT (US)

(73) Assignee: INTELLECT RESOURCES, INC., Greensboro, NC (US)

(21) Appl. No.: 13/287,896

(22) Filed: Nov. 2, 2011

(51) Int. Cl. G06Q 90/00

(52) U.S. Cl. 705/500

(57) ABSTRACT

A method for evaluating applicants for employment includes conducting a hiring event at a desired location, in which a plurality of applicants seeking employment can be present. The hiring event can include a speed interview phase, in which each applicant undergoes a series of successive interviews of limited duration, with each interview conducted by a different interviewer. The hiring event can also include a video phase, in which each applicant is given a plurality of questions and instructed to select one of the plurality of questions and answer the selected question in front of a video camera recording the applicant. The performance of each applicant in one phase of the hiring event is evaluated and used to determine whether each applicant may participate in another phase of the event.

### TECHNICAL FIELD AND BACKGROUND OF THE INVENTION

The present invention relates to a method for evaluating applicants for employment and making selections from among the applicants. In one embodiment of the invention, applicants complete a series of short “speed” interviews, each with a different interviewer who rates the applicant's performance in the interview. Depending on the results of the short speed interviews, applicants may be allowed to proceed to additional stages, such as a video stage, in which the applicant is asked several questions while being video taped and provided a short period of time to provide a free “open mike” type presentation on video. Depending on the scores attained at this stage, applicants may proceed to additional stages, such as a live panel stage in which applicants are given several topics and a brief period to speak on each topic in front of several evaluators.

Large corporate employers, such as hospitals and other health care facilities, often need to hire a large number of employees at once. The process of hiring those employees can be time consuming and expensive. As such, there is a need for a method of accurately evaluating a large number of employment applicants in an efficient and cost effective manner.

### SUMMARY OF THE INVENTION

One object of the present invention is to provide a method for efficiently evaluating and selecting candidates for employment from a large pool of applicants. Another object of the invention is to provide a method for hiring employees that enables a business to effectively evaluate a large number of candidates in a relatively short period of time. These and other objects of the present invention can be achieved in the preferred embodiments of the invention disclosed herein.

One embodiment of the invention comprises a method of evaluating a plurality of applicants for employment that includes the steps of providing a plurality of applicants comprising a plurality of individuals applying for employment, and conducting a hiring event at a desired location, wherein the plurality of applicants are present at the hiring event. In the hiring event, a series of speed interviews is conducted for each of the plurality of applicants at the hiring event, in which each applicant undergoes at least three successive interviews. Each interview lasts no more than about twenty minutes, and is conducted by a different interviewer. The performance of each applicant in the speed interviews is evaluated, and whether each applicant may further participate in the hiring event is determined based on the applicant's performance in the speed interviews.

According to another embodiment of the invention, a video phase is conducted at the hiring event, in which each applicant is given a plurality of questions, and instructed to select one of the plurality of questions and answer the selected question in front of a video camera recording the applicant. The performance of each applicant in the video phase is evaluated, and whether each applicant may further participate in the hiring event is determined based on the applicant's performance in the video phase.

According to another embodiment of the invention, one or more of the individuals evaluating the performance of the applicants in the video phase are disguised, such as camera operators or time keepers, so that the applicant is unaware that the individual is evaluating the applicant's performance.

According to another embodiment of the invention, each applicant is given at least four questions from which to select to answer in the video phase.

According to another embodiment of the invention, a live panel phase is conducted, in which each applicant is directed into a room having a panel of judges. Each applicant is assigned one or more topics, and given a predetermined amount of time to develop an impromptu presentation of a predetermined duration relating to the assigned topics. The judges evaluate the performance of each applicant in the live panel phase.

According to another embodiment of the invention, during the live panel phase each applicant is subjected to at least one unexpected stress inducing incident so that each applicant's ability to handle unexpected stress incidents can be evaluated.

According to another embodiment of the invention, the unexpected stress inducing incident can be lighting disruptions, room temperature fluctuations, equipment malfunctions, and/or questions from the judges.

According to another embodiment of the invention, an information session is conducted in which each applicant is directed into a holding room until a predetermined number of applicants are assembled, and applicants can be provided information regarding the employment positions the applicants have applied for and the procedure of notification if hired.

According to another embodiment of the invention, the information session can include questions from the applicants and responses thereto.

According to another embodiment of the invention, a location for the hiring event i is selected, and a a budget for the hiring event is determined.

According to another embodiment of the invention, a registration database for collecting and maintaining data relating to the applicants' registrations for the hiring event is provided.

According to another embodiment of the invention, an Internet landing page is provided, on which applicants can provide personal information and register for the hiring event.

According to another embodiment of the invention, applicants are required to correctly answer a predetermined number of skill based questions on the Internet landing page in order to be granted access to register for the hiring event.

According to another embodiment of the invention, a predetermined number of preferred applicants are selected to be extended offers of employment based on evaluation of the applicants' performance at the hiring event. In addition, a predetermined number of alternate applicants can be selected who may be extended offers of employment depending upon how many of the preferred applicants decline the offer of employment.

According to another embodiment of the invention, each applicants is notified as to whether the applicant has been selected to receive an offer of employment.

According to another embodiment of the invention, management responsibilities are assigned to selected individuals.

According to another embodiment of the invention, a method for evaluating a plurality of applicants for employment includes conducting a hiring event at a desired location, in which a plurality of applicants seeking employment are present at the hiring event, and the hiring event comprises a speed interview phase, in which each of the plurality of applicants participate in a series of successive interviews, with each interview conducted by a different interviewer. The hiring event also includes a video phase, in which each applicant is given a plurality of questions and instructed to select one of the plurality of questions and answer the selected question in front of a video camera recording the applicant.

According to another embodiment of the invention, the performance of each applicant in the speed interview phase is evaluated and used to determine whether each applicant may participate in the video phase.

According to another embodiment of the invention, each applicant participates in at least three successive interviews in the speed interview phase, with each of the interviews lasting no more than about fifteen minutes.

According to another embodiment of the invention, the hiring event includes a live panel phase, which includes the steps of directing each applicant into a room having a panel of judges therein for evaluating the performance of the applicant, and providing to each applicant a plurality of topics, and a predetermined amount of time to develop an impromptu presentation of a predetermined duration relating to each topic. Each applicant is subjected to at least one unexpected stress inducing incident during the live panel phase.

### DESCRIPTION OF THE PREFERRED EMBODIMENTS OF THE INVENTION AND BEST MODE

The following is a description of a method for evaluating and selecting applicants for employment according to a preferred embodiment of the invention. This embodiment of the invention comprises the general steps of event planning, marketing, registration process, client training, event execution, decision making, onboarding and management.

As used throughout this application, the term “client” refers generally to a business organization seeking to hire employees. “Consultant” refers generally to an individual and/or organization retained to assist the client in this endeavor.

In the event planning stage, the consultant consults with the client to develop an action plan and goals for a hiring event. This process includes establishment of timeliness, selection of a location, developing expectations and setting budgets for the hiring event.

A master services document is created to outline expenses, responsibilities and deliverables. Decisions can be made as to the level of involvement and responsibilities of the consultant and the client, respectively, in the process. Decisions regarding sponsorships of the hiring event can be made. For example, appropriate organizations, such as academic institutions, cosmetic companies, insurance companies, local restaurants, coffee shops, and clothing stores can be sponsors of the event. Engagement plans for trainers are developed jointly with the client and consultant including, but limited to, responsibility of vested parties, locations, training, credentialing, scheduling, day to day management, scheduling, communication vehicles, technology, supplies, materials, and hiring for future positions.

In the marketing step, the consultant can coordinate and direct marketing for the event, for example, public relations to tout benefits to the community, such as job creation, education and patient care improvements with the implementation of an electronic health record (if the client is a health care provider). Audio and video media campaigns can be implemented, including, but not limited to, production of a radio show and/or 2-3 minute promotional video commercial. Custom built micro website/pages can be created to highlight the client, opportunity and event registration links.

Mediums for delivering the marketing include, but are not limited to (i) marketing/public relations departments and employees of the client, (ii) Internet websites such as CRAIGSLIST, (iii) the consultant's database, (iv) the consultant's public relations, and (v) one-to-one recruiting by the consultant's recruiters.

If sponsorships are desired, both the client and consultant can co-develop sponsorship packages and assume responsibility for making connections. Namely sponsorship packages would include distribution of advertisements, coupons, promotional gifts or marketing materials, and booths on waiting areas.

In the registration process, the consultant builds a fully integrated registration and candidate management system (CMS), which can be the single point of all data collected throughout the registration process. The system integrates tightly with the consultant's applicant tracking system (ATS) for internal management of the hiring and on-boarding process.

A candidate visits a landing page (from numerous websites and links) where the candidate can “profile” for a particular job, answer skills based questions, and either be declined on the spot or advanced through the process to the hiring event. The consultant continually communicates with applicants via LinkedIn Groups and scheduled conference calls to field questions and maximize attendance the day of the hiring event.

In the client training step, the consultant can train the client on basic interviewing skills and workflow for the day of the hiring event. The consultant trains the client on evaluation criteria, and trains the client on use of the ATS system for real time candidate advancement and tracking in the ATS system.

In the hiring event, the consultant can manage onsite registration with personal touch and routes/tracks candidates both through live process and in the ATS. The consultant manages the interview process in collaboration with the client. The hiring event can include the following components: speed interview, video interview, live panel and an information session.

The speed interview is comprised of a “speed dating” style interview process, in which each applicant completes approximately three to five separate speed interviews to assess chemistry, motivation and ethics. Each interview can have a predetermined maximum duration, such as no more than twenty minutes. Preferably, each interview lasts approximately five to ten minutes, and is conducted by a different interviewer. Each interviewer scores the candidate, and the score can be aggregated or averaged for each applicant. Applicants can be dismissed or forwarded to the additional stages of the hiring event. At this speed interview stage, marginal or borderline applicants may be allowed to move forward to the next stage.

In the video stage, each applicant will be given a list of approximately four interview questions such as “tell me about yourself,” “discuss your strengths or weaknesses,” “tell me about your favorite career experience” or “why are you here.” The applicant can select one of the four questions and give a three to five minute “open mike” style presentation in front of the camera. Unbeknownst to the applicant, the interviewers/evaluators can be posed as timers and guides, and assess the applicants' presentation skills and score the applicants accordingly. Scores can be aggregated or averaged, and applicants can be either dismissed or advanced to the next step based on the aggregate or average score.

In the live panel stage, each applicant will be given a list of approximately four topics, and approximately thirty minutes to develop an impromptu three to five minute presentation for each topic. The applicants are ushered into a room with a panel of approximately four judges, and given one of the four topics to present. Interviewers can then assess how well the applicant handles pressure and “real life” situations where judges may ask questions or cause unexpected “chaos” such as turning the lights off and on, and other similar interruptions. Each judge scores each applicant. The scores can be aggregated or averaged, and applicants can either be dismissed or allowed to proceed to the next stage. At this stage, marginal or borderline applicants can be ushered forward to the next stage—the information session.

In the information session, each applicant can be ushered into a holding room until groups of approximately ten or more applicants are assembled. At which point, the consultant and the client inform applicants regarding the next steps, including plans for notification of selection, alternates, on boarding, other opportunities with the consultant or client, expectations for the employment position, duration, extension opportunities, go-live frenzy, future opportunities in the field of the client, credentialing process of the vendor, scheduling, benefits (if provided), dress code, training location, etc. Questions can be fielded from applicants. The consultant can print, distribute and collect appropriate pre-populated applications and any necessary consent forms, such as for background checks not collected during registration. This is also an opportunity for applicants to withdraw themselves from the process. Finally, any parking validations can be distributed as well as key codes to download materials from the consultant or client as a “thank you” for participating.

In the decision step, the consultant notifies all participants of the final outcomes of the process, and manages alternates to account for attrition and turn-downs.

In the onboarding step, the consultant manages the sending out of offer letters to selected applicants. The consultant can also manage alternate candidates who may receive an offer letter depending on the number of selected applicants who decline the offer of employment. The consultant collects and manages applicant's applications, waivers, tax forms, payroll documents, etc. The consultant can conduct background checks, and check references. If provided, the consultant provides an explanation of benefits. The consultant can hold conference calls to field questions during the onboarding process, and preparation for the first day, weeks on the job. The consultant can verify schedule preferences and collect blackout/vacation dates. The consultant can conduct a consultant charm school (CCS) to go over the client's expectations including, but not limited to, principles of “serving” the client, chain of communication, what to elevate, what to tolerate, timeliness, schedule issues, working with other consultants, dress code, status, time and expense reporting, and conflict resolution.

In the management step, all parties assume appropriate responsibilities for management. Areas of responsibilities can include (1) scheduling, (2) time sheet approval by the client, (3) training/credentialing of trainers, (4) daily management, including performance, dress code, tardiness, and delinquency, (5) human resources/conflict resolution, (6) communication of information updates, (7) management of terminations/extensions, (8) collection of status reports, and (9) issue resolution. Scheduling is preferably designated to one person. Time sheet approval is preferably designated to team leaders.

A method for evaluating and selecting applicants for employment. Various changes can be made to the invention without departing from its scope. For example, the steps of the methods described herein can be carried out in varying order and are not limited to any particular sequence. The above description of the preferred embodiments and best mode of the invention are provided for the purpose of illustration only and not limitation—the invention being defined by the claims, and equivalents thereof.

What is claimed is:

1. A method of evaluating a plurality of applicants for employment comprising the steps of:
(a) providing a plurality of applicants comprising a plurality of individuals applying for employment;
(b) conducting a hiring event at a desired location, wherein the plurality of applicants are present at the hiring event;
(c) conducting a series of speed interviews for each of the plurality of applicants at the hiring event, wherein each applicant undergoes at least three successive interviews, each interview having a predetermined maximum duration, and conducted by a different interviewer; and
(d) evaluating the performance of each applicant in the speed interviews, and determining whether each applicant may further participate in the hiring event based on the applicant's performance in the speed interviews.

2. A method according to claim 1, further comprising the steps of:
(a) conducting a video phase at the hiring event, wherein each applicant is given a plurality of questions and instructed to select one of the plurality of questions and answer the selected question in front of a video camera recording the applicant; and
(b) evaluating the performance of each applicant in the video phase, and determining whether each applicant may further participate in the hiring event based on the applicant's performance in the video phase.

3. A method according to claim 2, further comprising the step of providing at least one individual for evaluating the performance of each applicant in the video phase, wherein said individual is disguised whereby the applicant is unaware that the individual is evaluating the applicant's performance.

4. A method according to claim 2, wherein the plurality of questions comprise at least four questions.

5. A method according to claim 1, further comprising the step of conducting a live panel phase, wherein each applicant is directed into a room having a panel of judges therein, each applicant is assigned at least one topic, and given a predetermined amount of time to develop an impromptu presentation of a predetermined duration relating to the at least one topic, and the judges evaluate the performance of each applicant in the live panel.

6. A method according to claim 5, wherein the live panel phase includes the step of subjecting each applicant to at least one unexpected stress inducing incident whereby each applicant's ability to handle unexpected stress incidents can be evaluated.

7. A method according to claim 6, wherein the at least one unexpected stress inducing incident is selected from the group consisting of lighting disruptions, room temperature fluctuations, equipment malfunctions, and questions from the judges.

8. A method according to claim 1, further comprising the step of conducting an information session, wherein:
(a) each applicant is directed into a holding room until a predetermined number of applicants are assembled;
(b) applicants are provided information regarding the employment positions the applicants have applied for and the procedure of notification if hired;
(c) questions from applicants are answered.

9. A method according to claim 1, wherein the predetermined maximum duration of each interview in the series of speed interviews is twenty minutes.

10. A method according to claim 1, further comprising the steps of:
(a) selecting a location for the hiring event; and
(b) determining a budget for the hiring event.

11. A method according to claim 1, further comprising the step of providing a registration database for collecting and maintaining data relating to the applicants' registrations for the hiring event.

12. A method according to claim 1, further comprising the step of providing an Internet landing page wherein applicants can provide personal information and register for the hiring event.

13. A method according to claim 12, wherein applicants must correctly answer a predetermined number of skill based questions on the Internet landing page in order to register for the hiring event.

14. A method according to claim 1, further comprising the steps of:
(a) selecting among the plurality of applicants a predetermined number of preferred applicants to be extended offers of employment based on evaluation of the applicants' performance at the hiring event; and
(b) selecting among the plurality of applicants a predetermined number of alternate applicants who may be extended offers of employment depending upon how many of the preferred applicants decline the offer of employment.

15. A method according to claim 14, further comprising the step of notifying each of the plurality of applicants as to whether the applicant has been selected to receive an offer of employment.

16. A method according to claim 1, further comprising the step of assigning management responsibilities to selected individuals.

17. A method of evaluating a plurality of applicants for employment comprising conducting a hiring event at a desired location, wherein a plurality of applicants seeking employment are present at the hiring event, and the hiring event comprises:
(a) a speed interview phase wherein each of the plurality of applicants undergo a series of successive interviews, each interview having a maximum predetermined duration and conducted by a different interviewer; and
(b) a video phase wherein each applicant is given a plurality of questions and instructed to select one of the plurality of questions and answer the selected question in front of a video camera recording the applicant.

18. A method according to claim 17, further comprising the step of evaluating the performance of each applicant in the speed interview phase, and determining whether each applicant may participate in the video phase based on the applicant's performance in the speed interview phase.

19. A method according to claim 17, wherein the series of successive interviews in the speed interview phase comprises at least three interviews, and the predetermined maximum duration of each of the interviews is about ten minutes.

20. A method according to claim 18, wherein the hiring event further comprises a live panel phase, comprising the steps of:
(a) directing each applicant into a room having a panel of judges therein for evaluating the performance of the applicant;
(b) providing to each applicant a plurality of topics, and a predetermined amount of time to develop an impromptu presentation of a predetermined duration relating to each of the plurality of topics;
(c) subjecting each applicant to at least one unexpected stress inducing incident.
